(19) United States
(12) Patent Application Publication
(10) Pub. No.: US 2026/0278919 A1
(43) Pub. Date: Sep. 17, 2026

(54) GENERATING PORTRAITS ACCORDING TO RELIGHTING SCHEMES USING DIFFUSION MODELS TRAINED ON SYNTHETIC IMAGE DATA

(71) Applicant: Adobe Inc., San Jose, CA (US)

(72) Inventors: Zhixin Shu, San Jose, CA (US); Sumit Chaturvedi, New Haven, CT (US); Mengwei Ren, San Jose, CA (US); Yannick Hold-Geoffroy, Quebec City (CA); Jingyuan Liu, Santa Clara, CA (US)

(21) Appl. No.: 19/079,071

(22) Filed: Mar. 13, 2025

(51) Int. Cl. G06T 15/50; G06T 5/50; G06T 5/60; G06T 5/70; G06T 15/04; G06T 17/20

(52) U.S. Cl. CPC G06T 15/506; G06T 5/50; G06T 5/60; G06T 5/70; G06T 15/04; G06T 17/20; G06T 2200/24; G06T 2207/20081; G06T 2207/20084; G06T 2215/12

(57) ABSTRACT

The present disclosure relates to systems, non-transitory computer-readable media, and methods for generating, utilizing a diffusion model, digital images depicting portraits relit according to a new lighting scheme. In particular, in some embodiments, the disclosed systems generate, utilizing a diffusion model, a first noised image based on a first digital image comprising a portrait of a subject and based on an environment map defining a new lighting scheme for the subject. In addition, in some embodiments, the disclosed systems generate, utilizing the diffusion model, a second noised image based on the environment map and a text prompt comprising a description of the subject. Furthermore, in some embodiments, the disclosed systems generate, utilizing the diffusion model, a new digital image comprising a relit portrait of the subject by combining the first noised image and the second noised image.

### BACKGROUND

Lighting is an important aspect of portrait photography, and advancements have been made with technologies that provide tools to manipulate portrait lighting after capture. Ensuring that lighting of modified portions (e.g., generated or edited content) of digital images is consistent is an important and often challenging aspect of synthetically modifying digital images to create or retain realism. Specifically, image editing processes often involve inserting digital content from one digital image into another digital image or inserting synthetically generated content into a digital image, resulting in inconsistent lighting (e.g., direction, color, intensity) without adjustments to the lighting of the inserted content. However, existing systems continue to fall short in efforts to change a portrait's lighting scheme. In particular, existing systems often struggle both to accurately relight a portrait and to maintain personal details of a subject of the portrait.

### BRIEF SUMMARY

Embodiments of the present disclosure provide benefits and/or solve one or more problems in the art with systems, non-transitory computer-readable media, and methods for generating relit portraits utilizing diffusion models trained on synthetic image data. To illustrate, in one or more embodiments, the disclosed systems train a diffusion model to relight digital images while preserving subject identities and photorealism utilizing a multitask training approach. In particular, in some embodiments, the disclosed systems utilize a relighting task to train the diffusion model with synthetic image pair data. For instance, the disclosed systems utilize a first synthetic image as an input to the diffusion model, where the first synthetic image includes a synthetic portrait of a subject under a first lighting condition. Additionally, in some embodiments, the disclosed systems utilize a second synthetic image as a ground truth for training the diffusion model to learn changes in lighting from the first synthetic image to the ground truth, where the second synthetic image includes a synthetic portrait of the subject under a second lighting condition.

Moreover, in one or more embodiments, the disclosed systems utilize a text-to-portrait task to further train the diffusion model with real image data (e.g., images containing real world portraits). For example, the disclosed systems utilize a text caption of a real image as a prompt for the diffusion model to generate an image that illustrates a subject described by the prompt. Additionally, in some embodiments, the disclosed systems utilize the real image as a ground truth for training the diffusion model.

Furthermore, in one or more embodiments, the disclosed systems utilize a dual diffusion process during inference to generate a new image depicting a portrait under a new lighting scheme. In particular, in some embodiments, the disclosed systems generate a first noised image based on an input image, an environment map, and a text caption for the input image. Additionally, in some embodiments, the disclosed systems generate a second noised image based on the environment map and the text caption, while dropping out the input image from the input channel to the diffusion model. Moreover, in one or more embodiments, the disclosed systems combine the first and second noised images in a reverse diffusion process (i.e., a denoising process of the diffusion model) to generate a new digital image that depicts the subject in the new lighting scheme of the environment map.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a portrait relighting system operates in accordance with one or more embodiments.

FIG. 2 illustrates the portrait relighting system generating a new digital image with a relit portrait of a subject from an input portrait in accordance with one or more embodiments.

FIG. 3 illustrates synthetic portrait pairs of the portrait relighting system in accordance with one or more embodiments.

FIG. 4 illustrates the portrait relighting system utilizing a multitask training approach to train a diffusion model to generate relit portraits in accordance with one or more embodiments.

FIG. 5 illustrates the portrait relighting system modifying parameters of the diffusion model in a multitask training framework in accordance with one or more embodiments.

FIG. 6 illustrates the portrait relighting system applying a dual diffusion process during inference that balances between identity preservation of the subject and the desired relighting effects as specified by the environment map, in accordance with one or more embodiments.

FIG. 7 illustrates the portrait relighting system providing a new digital image for display via a graphical user interface of a client device in accordance with one or more embodiments.

FIG. 8 illustrates an example of a guided diffusion model in accordance with one or more embodiments.

FIG. 9 illustrates an example of a U-Net in accordance with one or more embodiments.

FIG. 10 illustrates an example method for conditional media generation in accordance with one or more embodiments.

FIG. 11 illustrates a diffusion process in accordance with one or more embodiments.

FIG. 12 illustrates a flow diagram depicting an algorithm as a step-by-step procedure for training a machine-learning model in accordance with one or more embodiments.

FIG. 13 illustrates an example method for training a diffusion model in accordance with one or more embodiments.

FIG. 14 illustrates an example computing apparatus in accordance with one or more embodiments.

FIG. 15 illustrates a diagram of an example architecture of the portrait relighting system in accordance with one or more embodiments.

FIG. 16 illustrates a flowchart of a series of acts for generating a digital image with a relit portrait utilizing a diffusion model in accordance with one or more embodiments.

FIG. 17 illustrates a block diagram of an example computing device for implementing one or more embodiments of the present disclosure.

### DETAILED DESCRIPTION

This disclosure describes one or more embodiments of a portrait relighting system that generates relit portraits utilizing diffusion models trained on synthetic image data. To illustrate, in one or more embodiments, the portrait relighting system trains a diffusion model to relight digital images while preserving subject identities and photorealism utilizing a multitask training approach. For example, the portrait relighting system utilizes a relighting task to train the diffusion model with synthetic image pair data to accurately reflect illumination effects defined by a target environment. Additionally, the portrait relighting system utilizes a text-to-portrait task to further train the diffusion model with real image data to preserve subject identities and maintain photorealism in the final rendering.

As mentioned, in one or more embodiments, the portrait relighting system trains a diffusion model utilizing a relighting task involving synthetic images. For instance, the portrait relighting system utilizes a first synthetic image as an input to the diffusion model, where the first synthetic image includes a synthetic portrait of a subject under a first lighting condition. Additionally, the portrait relighting system utilizes a second synthetic image as a ground truth for training the diffusion model, where the second synthetic image includes a synthetic portrait of the subject under a second lighting condition. By training the diffusion model with synthetic portrait pairs that reflect different lighting conditions, the portrait relighting system trains the diffusion model to generate new portraits accurately according to different lighting schemes.

Moreover, in one or more embodiments, the portrait relighting system utilizes a text-to-portrait task to further train the diffusion model with real image data. For example, the portrait relighting system utilizes a text caption of a real image as a prompt for the diffusion model to generate an image that illustrates a subject described by the prompt. Additionally, the portrait relighting system utilizes the real image as a ground truth for training the diffusion model. By training the diffusion model with text captions paired with real images, the portrait relighting system helps the diffusion model to overcome a potential domain gap between the synthetic image training and real-world imagery.

Furthermore, in one or more embodiments, the portrait relighting system utilizes a dual diffusion process during inference to generate a new image depicting a portrait under a new lighting scheme. In particular, in some embodiments, the portrait relighting system generates a first noised image based on an input image, an environment map defining the new lighting scheme, and a text caption describing the input image. Additionally, in some embodiments, the portrait relighting system generates a second noised image based on the environment map and the text caption, while dropping out the input image from the input channel to the diffusion model. Moreover, in one or more embodiments, the portrait relighting system combines the first and second noised images in a reverse diffusion process to generate a new digital image that depicts a new portrait of the subject in the new lighting scheme as defined by the environment map. By applying this dual diffusion process, the portrait relighting system helps the diffusion model to achieve a balance between preserving details and identity of the subject with performing a reasonable relighting to the portrait.

Although existing systems generate new images with different lighting from input images, such systems have a number of problems in relation to accuracy. For instance, existing systems often inaccurately apply a new lighting scheme and/or change important details of a portrait's subject. For example, some existing systems are trained on data captured from light stage setups, which limits the types of lighting that can be captured. Such existing systems are trained with samples that have restricted light intensity and/or lighting resolution, thus hindering the ability of the existing systems to learn complex lighting effects such as specular reflections and subsurface scattering. Thus, some existing systems do a poor job of representing the desired lighting conditions in the relit portrait.

The portrait relighting system provides improvements over existing systems. For example, the portrait relighting system improves accuracy of image generation relative to existing systems. Specifically, the portrait relighting system generates relit portraits that maintain the integrity of personal details of a subject while also capturing the new lighting environment defined by an environment map. Moreover, the portrait relighting system has demonstrated both qualitative and quantitative enhancements over existing systems, as discussed in additional detail below. In particular, by training the diffusion model with synthetic pairs, the portrait relighting system improves on the relighting capabilities of existing systems, while maintaining visual identity preservation of portrait subjects thanks to the multitask training framework and the dual diffusion process at inference time that help to close the gap between the synthetic and real-world domains.

More particularly, by training (e.g., finetuning) a diffusion model using synthetic portrait pairs that reflect a change in lighting conditions, the portrait relighting system provides improved relighting capabilities over existing systems by training the diffusion model to focus on changes to illumination effects that result from changing from an initial lighting condition to a target lighting condition. Additionally, by training (e.g., finetuning) the diffusion model using a text-to-portrait task grounded with real-world images, the portrait relighting system maintains the photorealism of the diffusion model outputs. Thus, the portrait relighting system offers enhancements in relighting capabilities over existing systems by producing relit portraits that more accurately reflect desired lighting changes while retaining photorealism of the subjects of the portraits.

Furthermore, by using a dual diffusion track that combines two noised images during each diffusion step at inference, the portrait relighting system provides additional enhancements in photorealism and accurate relighting over existing systems. In particular, by generating a first noised image conditioned with the input image and a second noised image conditioned without the input image (e.g., conditioned only with the target lighting scheme and a text caption for the subject), the portrait relighting system achieves balance between preserving identifying details of the subject and reasonably relighting the portrait scene. As discussed below, the portrait relighting system has been shown to provide improvements over three existing systems in a user study that measured user preferences for relighting effects, subject identity preservation, and image quality.

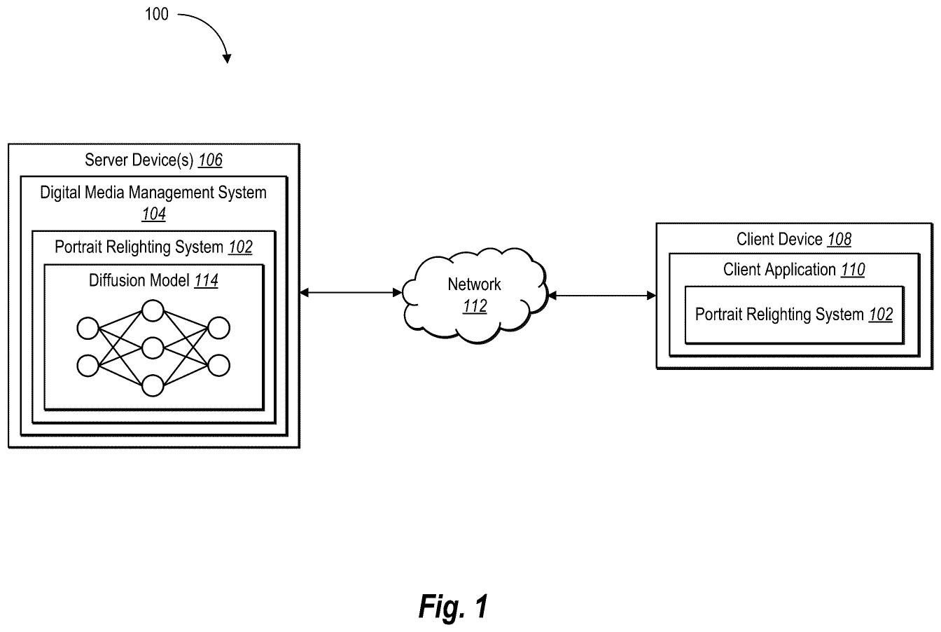

Additional detail will now be provided in relation to illustrative figures portraying example embodiments and implementations of a portrait relighting system. For example, FIG. 1 illustrates a system 100 (or environment) in which a portrait relighting system 102 operates in accordance with one or more embodiments. As illustrated, the system 100 includes server device(s) 106, a network 112, and a client device 108. As further illustrated, the server device(s) 106 and the client device 108 communicate with one another via the network 112.

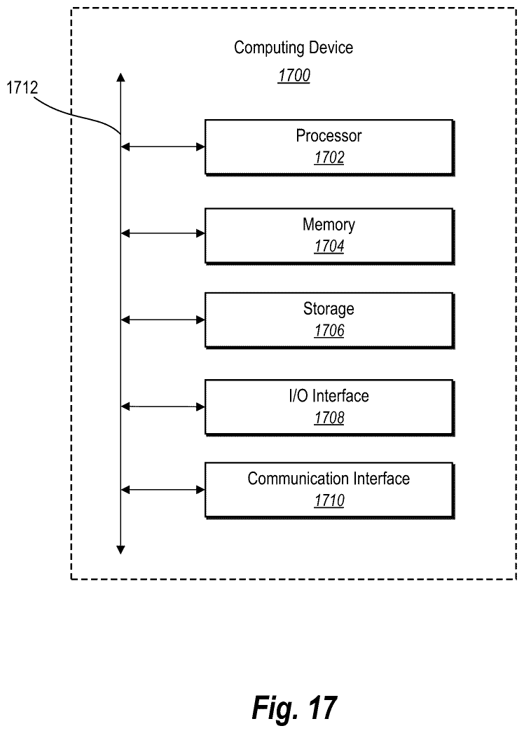

As shown in FIG. 1, the server device(s) 106 includes a digital media management system 104 that further includes the portrait relighting system 102. In some embodiments, the portrait relighting system 102 utilizes one or more machine learning models (e.g., a media generation model, such as a diffusion model 114) to generate relit portraits. For example, in some implementations, the portrait relighting system 102 utilizes the machine learning models to generate a new digital image depicting a portrait with lighting effects according to a new lighting scheme. In some embodiments, the server device(s) 106 includes, but is not limited to, a computing device (such as explained below with reference to FIG. 17).

In one or more embodiments, a machine learning model includes a computer representation that is tunable (e.g., trained) based on inputs to approximate unknown functions used for generating corresponding outputs. In particular, in one or more embodiments, a machine learning model is a computer-implemented model that utilizes algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a transformer-based model, a diffusion model, or a combination thereof.

Similarly, in one or more embodiments, a neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer neural network, a classifier neural network, or a generative adversarial neural network.

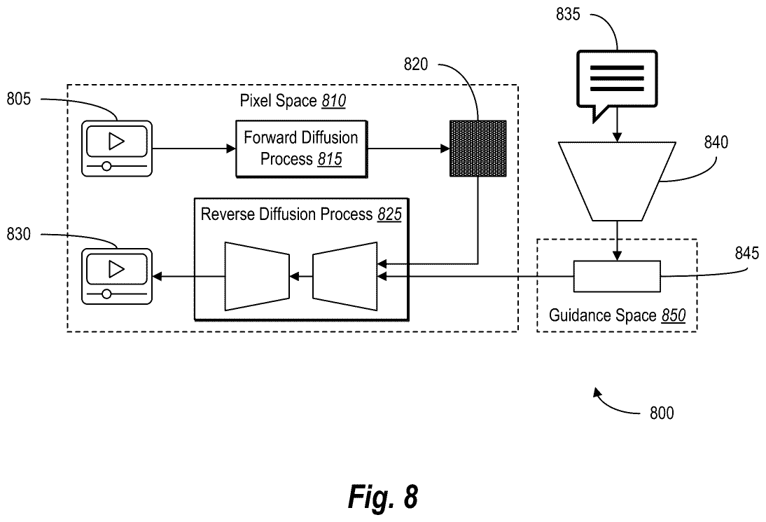

A diffusional model (or diffusion neural network) refers to a likelihood-based model for image synthesis. In particular, a diffusion model is based on a Gaussian denoising process (e.g., based on a premise that the noises added to the original images are drawn from Gaussian distributions). The denoising process involves predicting the added noises using a neural network (e.g., a convolutional neural network such as UNet). During training, Gaussian noise is iteratively added to a digital image in a sequence of steps (or iterations) to generate a noise map (or noise representation). The neural network is trained to recreate the digital image by reversing the noising process. In particular, the diffusion neural network utilizes a plurality of steps (or iterations) to iteratively denoise the noise representation. The diffusion neural network thus generates digital images from noise representations. FIGS. 8-14 and the corresponding description provide additional detail related to diffusion models.

In some instances, the portrait relighting system 102 receives a request (e.g., from the client device 108) to relight a portrait. For example, the portrait relighting system 102 obtains a digital image depicting the portrait, and an environment map defining a new lighting condition for the portrait. Some embodiments of server device(s) 106 perform a variety of functions via the digital media management system 104 on the server device(s) 106. To illustrate, the server device(s) 106 (through the portrait relighting system 102 on the digital media management system 104) performs functions such as, but not limited to, training a diffusion model to generate a portrait with altered lighting based on an input portrait and an environment map defining a new lighting scheme, and generating a new digital image comprising a relit portrait of a subject depicted in an input digital image. In some embodiments, the server device(s) 106 utilizes the diffusion model 114 to generate the new image comprising the relit portrait. In some embodiments, the server device(s) 106 trains the diffusion model 114.

Furthermore, as shown in FIG. 1, the system 100 includes the client device 108. In some embodiments, the client device 108 includes, but is not limited to, a mobile device (e.g., a smartphone, a tablet), a laptop computer, a desktop computer, or any other type of computing device, including those explained below with reference to FIG. 17. Some embodiments of client device 108 perform a variety of functions via a client application 110 on client device 108. For example, the client device 108 (through the client application 110) performs functions such as, but not limited to, training a diffusion model to generate a portrait with altered lighting based on an input portrait and an environment map defining a new lighting scheme, and generating a new digital image comprising a relit portrait of a subject depicted in an input digital image. In some embodiments, the client device 108 utilizes the diffusion model 114 to generate the new image comprising the relit portrait. In some embodiments, the client device 108 trains the diffusion model 114.

To access the functionalities of the portrait relighting system 102 (as described above and in greater detail below), in one or more embodiments, a user interacts with the client application 110 on the client device 108. For example, the client application 110 includes one or more software applications (e.g., to generate relit portraits in accordance with one or more embodiments described herein) installed on the client device 108, such as a digital media management application, an image editing application, and/or a graphic design application. In certain instances, the client application 110 is hosted on the server device(s) 106. Additionally, when hosted on the server device(s) 106, the client application 110 is accessed by the client device 108 through a web browser and/or another online interfacing platform and/or tool. Furthermore, in some embodiments, the client device 108, the server device(s) 106, or another system host one or more databases including digital data.

As illustrated in FIG. 1, in some embodiments, the portrait relighting system 102 is hosted by the client application 110 on the client device 108 (e.g., additionally, or alternatively to being hosted by the digital media management system 104 on the server device(s) 106). For example, the portrait relighting system 102 performs the portrait relighting techniques described herein on the client device 108. In some implementations, the portrait relighting system 102 utilizes the server device(s) 106 to train and implement machine learning models (such as the diffusion model 114). In one or more embodiments, the portrait relighting system 102 utilizes the server device(s) 106 to train machine learning models (such as the diffusion model 114) and utilizes the client device 108 to implement or apply the machine learning models.

Further, although FIG. 1 illustrates the portrait relighting system 102 being implemented by a particular component and/or device within the system 100 (e.g., the server device(s) 106 and/or the client device 108), in some embodiments the portrait relighting system 102 is implemented, in whole or in part, by other computing devices and/or components in the system 100. For instance, in some embodiments, the portrait relighting system 102 is implemented on another client device. More specifically, in one or more embodiments, the description of (and acts performed by) the portrait relighting system 102 are implemented by (or performed by) the client application 110 on another client device.

In some embodiments, the client application 110 includes a web hosting application that allows the client device 108 to interact with content and services hosted on the server device(s) 106. To illustrate, in one or more implementations, the client device 108 accesses a web page or computing application supported by the server device(s) 106. The client device 108 provides input to the server device(s) 106 (e.g., a request to generate a relit portrait). In response, the portrait relighting system 102 on the server device(s) 106 performs operations described herein to generate a new digital image depicting the portrait under new lighting conditions according to the request. The server device(s) 106 provides the output or results of the operations (e.g., a new digital image depicting the relit portrait) to the client device 108. As another example, in some implementations, the portrait relighting system 102 on the client device 108 performs operations described herein to generate a new digital image depicting the portrait under new lighting conditions according to the request. The client device 108 provides the output or results of the operations (e.g., a new digital image depicting the relit portrait) via a display of the client device 108, and/or transmits the output or results of the operations to another device (e.g., the server device(s) 106 and/or another client device).

Additionally, as shown in FIG. 1, the system 100 includes the network 112. As mentioned above, in some instances, the network 112 enables communication between components of the system 100. In certain embodiments, the network 112 includes a suitable network and communicates using any communication platforms and technologies suitable for transporting data and/or communication signals, examples of which are described with reference to FIG. 17. Furthermore, although FIG. 1 illustrates the server device(s) 106 and the client device 108 communicating via the network 112, in certain embodiments, the various components of the system 100 communicate and/or interact via other methods (e.g., the server device(s) 106 and the client device 108 communicate directly).

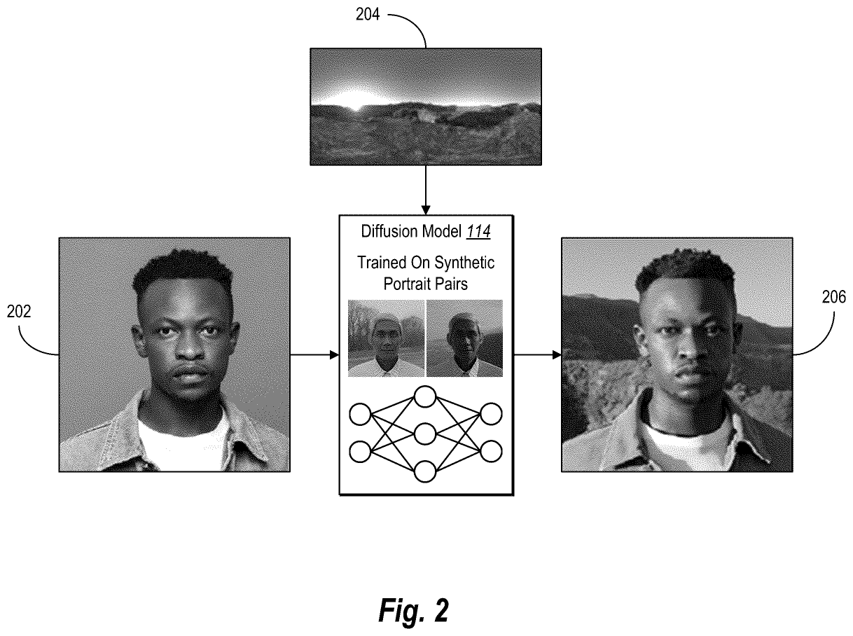

As discussed above, in one or more embodiments, the portrait relighting system 102 utilizes a diffusion model to relight a portrait of a subject based on an environment map defining a new lighting scheme for the subject. For instance, FIG. 2 illustrates the portrait relighting system 102 generating a new digital image with a relit portrait of a subject from an input portrait in accordance with one or more embodiments.

Specifically, FIG. 2 shows the portrait relighting system 102 accessing an input digital image 202 that has a portrait of a subject (e.g., a person or object). Additionally, FIG. 2 shows the portrait relighting system 102 accessing an environment map 204 that defines a new lighting scheme for the subject of the input digital image 202. For example, the portrait relighting system 102 receives the input digital image 202 and the environment map 204 from a client device (e.g., via a user input). A digital image includes a still image captured or generated digitally. In some cases, a digital image includes a frame of a digital video.

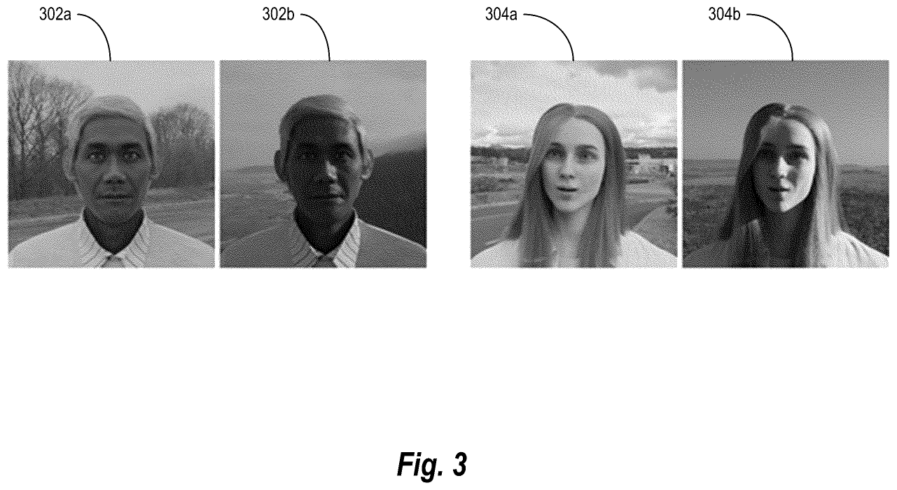

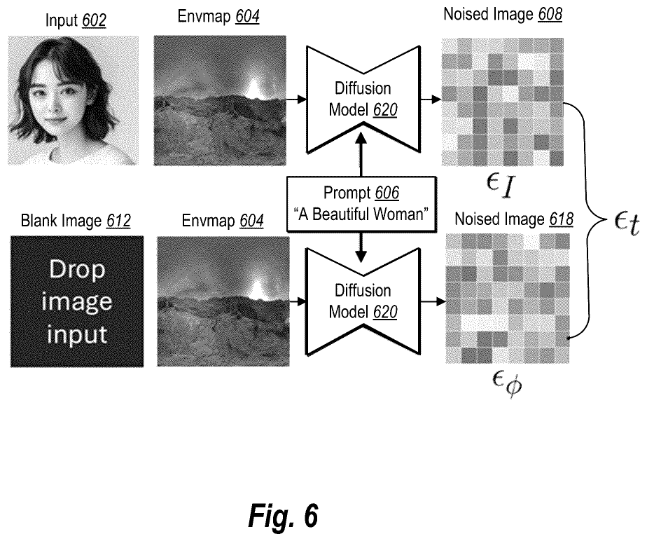

Moreover, FIG. 2 shows the portrait relighting system 102 processing the input digital image 202 and the environment map 204 through the diffusion model 114 to generate a new digital image 206 that has a relit portrait of the subject. For example, the portrait relighting system 102 generates the relit portrait by modifying a lighting (e.g., direction, color, intensity) of the subject of the input digital image 202. In one or more embodiments, the portrait relighting system 102 trains the diffusion model 114 with synthetic portrait pair data, as discussed in additional detail in connection with FIGS. 3-5. Furthermore, in one or more embodiments, the portrait relighting system 102 generates the new digital image 206 by combining two noised images from the diffusion model 114, as described below in connection with FIG. 6. Additional detail about how the portrait relighting system 102 trains and utilizes a diffusion model to generate new digital images is given below in connection with FIGS. 8-15.

In some implementations, the portrait relighting system 102 utilizes a pre-trained diffusion model and fine-tunes the diffusion model using the synthetic portrait pairs and the text/image training data. For example, the diffusion model 114 is a latent diffusion model pretrained on real-world images for text-to-image generation, and the portrait relighting system 102 finetunes the diffusion model 114 with physically based rendering of human heads under varying lighting conditions to train the diffusion model 114 to learn pixel transformations conditioned on lighting.

Moreover, as discussed in additional detail below, to overcome a domain gap between synthetic data and real images, the portrait relighting system 102 utilizes techniques that enable synthetic data learning while minimizing the domain gap with real images. In particular embodiments, the portrait relighting system 102 uses a multitask training strategy that incorporates real images through a text-to-image task (as a supplement to training with the synthetic data). Additionally, the portrait relighting system 102 utilizes a dual diffusion strategy at inference time that helps to preserve portrait details in the relit result.

To elaborate further, and with continued reference to FIG. 2, in one or more embodiments, the portrait relighting system 102 receives the input digital image 202 that was captured under unknown illumination conditions. Furthermore, the portrait relighting system 102 synthesizes a relit version of the portrait under a target lighting environment specified by a panoramic environment map 204. In one or more embodiments, the relit portrait simultaneously preserves the subject's facial identity and/or other subject characteristics from the original image, accurately reflects the illumination effects defined by the target environment map, and maintains photorealism in the final rendering.

As mentioned, in one or more embodiments, the portrait relighting system 102 trains a diffusion model on synthetic portrait pair data. More particularly, in some embodiments, the portrait relighting system 102 generates synthetic portrait pairs to train the diffusion model. For instance, FIG. 3 illustrates synthetic portrait pairs of the portrait relighting system 102 in accordance with one or more embodiments. To illustrate, the portrait relighting system 102 renders textured, high-quality three-dimensional head meshes that include facial details such as eyes, teeth, gums, and hair. The portrait relighting system 102 augments the base models through rigging for pose variation and blendshape deformation for diverse facial expressions. Moreover, the portrait relighting system 102 renders subjects in varies appearance samples, including different hairstyles, skin tones, expressions, clothes, and poses. For each sample, in some embodiments, the portrait relighting system 102 renders with a random selection of HDR environment maps, each of which is rotated with a random initial rotation. In some cases, the portrait relighting system 102 generates a training dataset of millions of synthetic images.

Furthermore, FIG. 3 shows a first synthetic portrait pair 302a, 302b, and a second synthetic portrait pair 304a, 304b. The first synthetic portrait pair includes a first synthetic digital image 302a with a first portrait of a first subject and a second synthetic digital image 302b with a second portrait of the first subject. As shown, the second portrait of the second synthetic digital image 302b has a different lighting condition than the first portrait of the first synthetic digital image 302a.

Similarly, the second synthetic portrait pair includes a first synthetic digital image 304a with a first portrait of a second subject and a second synthetic digital image 304b with a second portrait of the second subject. As shown, the second portrait of the second synthetic digital image 304b has a different lighting condition than the first portrait of the first synthetic digital image 304a.

In one or more embodiments, the portrait relighting system 102 generates the synthetic portrait pair data. For example, the portrait relighting system 102 generates the first synthetic digital image 302a by synthesizing a first rendering of the first subject according to a first lighting scheme. Similarly, in one or more embodiments, the portrait relighting system 102 generates the second synthetic digital image 302b by synthesizing a second rendering of the first subject according to a new lighting scheme (e.g., as defined by an environment map). As discussed below, in some implementations, the portrait relighting system 102 utilizes the second synthetic digital image 302b as a ground truth synthetic digital image in a training process for a diffusion model.

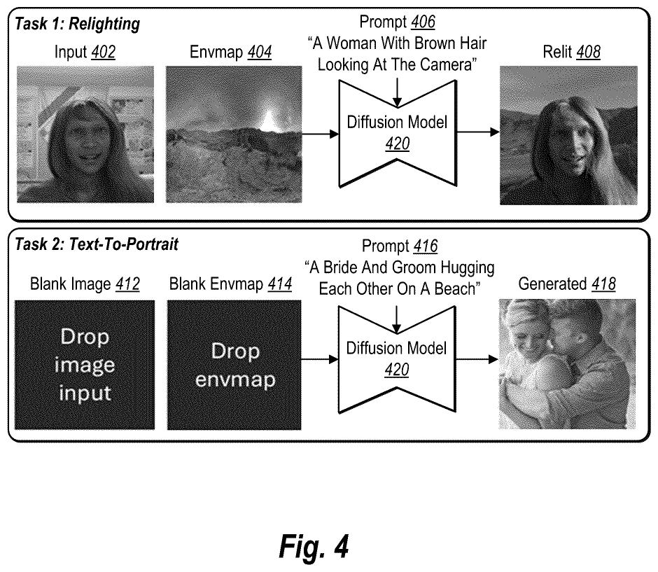

As discussed above, in one or more embodiments, the portrait relighting system 102 trains a diffusion model to generate a digital image that has a relit portrait. For instance, FIG. 4 illustrates the portrait relighting system 102 utilizing a multitask training approach to train a diffusion model to generate relit portraits in accordance with one or more embodiments.

Specifically, FIG. 4 shows a multitask training process that includes a relighting task and a text-to-portrait task. In the relighting task, in some embodiments, the portrait relighting system 102 accesses a first synthetic digital image 402 having a first portrait of a subject, and an environment map 404 defining a new lighting scheme for the subject. The portrait relighting system 102 processes the first synthetic digital image 402 and the environment map 404 through a diffusion model 420 (e.g., the diffusion model 114 of FIG. 1) to generate a second synthetic digital image 408 having a relit portrait of the subject. For example, the portrait relighting system 102 utilizes the diffusion model 420 to generate the second synthetic digital image 408 based on the first synthetic digital image 402 and the environment map 404. To further illustrate, in some embodiments, the portrait relighting system 102 concatenates latent representations of the input image and the environment map along a channel axis to process through the diffusion model 420 (e.g., via a UNet of the diffusion model 420).

In addition, in some implementations, the portrait relighting system 102 utilizes a text prompt to condition the diffusion model 420 when generating the second synthetic digital image 408. For instance, the portrait relighting system 102 utilizes the diffusion model 420 to generate the second synthetic digital image 408 from the first synthetic digital image 402 and the environment map 404 conditioned with a supplemental text prompt 406 comprising a description of the subject. For example, FIG. 4 shows a supplemental text prompt 406 describing the subject as “a woman with brown hair looking at the camera.” In one or more embodiments, the portrait relighting system 102 accesses text captions, such as the supplemental text prompt 406, for synthetic training images and uses the text captions to condition the diffusion model 420 when training the diffusion model 420 with the relighting task.

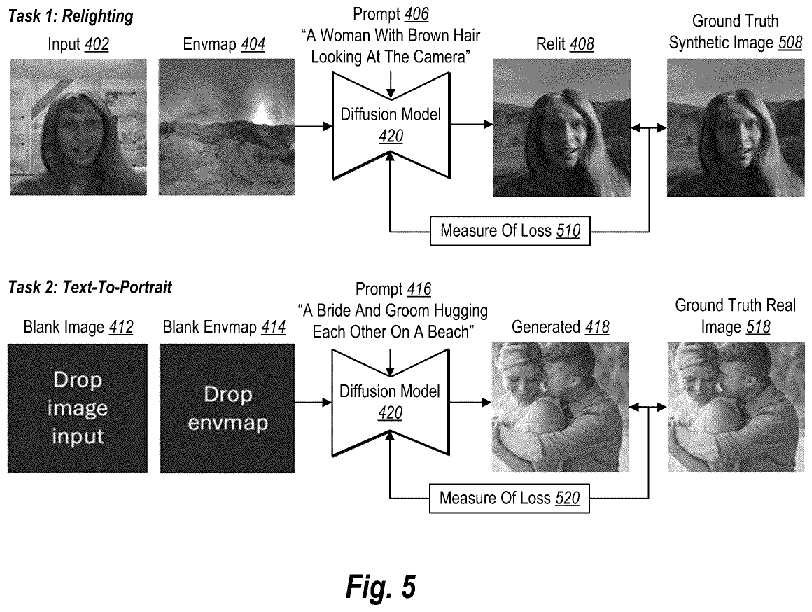

Moreover, in one or more embodiments, the portrait relighting system 102 modifies parameters of the diffusion model 420 based on the second synthetic digital image 408, as discussed further in connection with FIG. 5 below. As mentioned, in one or more embodiments, the portrait relighting system 102 uses the relighting task to help the diffusion model 420 to learn pixel transformations conditioned on lighting.

In the text-to-portrait task, in some embodiments, the portrait relighting system 102 generates a third digital image 418 based on a text prompt 416 that has a description of an additional subject (i.e., different from the subject of the first synthetic digital image 402). For example, the portrait relighting system 102 generates, utilizing the diffusion model 420, the third digital image 418 having a generated portrait of the additional subject based on the text prompt 416. For instance, FIG. 4 shows the text prompt 416 describing the additional subject as “a bride and groom hugging each other on a beach.” In one or more embodiments, the portrait relighting system 102 accesses additional text captions, such as the text prompt 416, for real training images and uses the additional text captions to condition the diffusion model 420 when training the diffusion model 420 with the text-to-portrait task.

As further shown in FIG. 4, in one or more embodiments, the portrait relighting system 102 drops the image and environment map inputs to the diffusion model 420 when training the diffusion model 420 with the text-to-portrait task. For example, the portrait relighting system 102 utilizes the diffusion model 420 to generate the third digital image 418 from a blank image 412 and a blank environment map 414 conditioned with the text prompt 416. In some embodiments, the blank image 412 is a digital image with only black pixels. In some embodiments, the blank image 412 is a digital image with pixels of a solid color (e.g., black or another color). In alternative embodiments, the blank image 412 is a digital image with transparency pixels. Similarly, in one or more embodiments, the blank environment map 414 is a black image (e.g., with no light sources represented).

Furthermore, in one or more embodiments, the portrait relighting system 102 modifies parameters of the diffusion model 420 based on the third digital image 418, as discussed further in connection with FIG. 5 below. As mentioned, in one or more embodiments, the portrait relighting system 102 uses the text-to-portrait task to help the diffusion model 420 produce realistic portrait images given an input prompt. By training the diffusion model 420 with the text-to-portrait task alongside the relighting task, the portrait relighting system 102 improves the photorealism and generalization of the trained diffusion model.

As discussed, in one or more embodiments, the portrait relighting system 102 trains a diffusion model to generate a digital image having a relit portrait. For instance, FIG. 5 illustrates the portrait relighting system 102 modifying parameters of the diffusion model in a multitask training framework in accordance with one or more embodiments.

Specifically, FIG. 5 shows the multitask training framework including a relighting task and a text-to-portrait task, as described above in connection with FIG. 4. Additionally, FIG. 5 shows the portrait relighting system 102 comparing the outputs of the diffusion model 420 with ground truth data to determine measures of loss and tune the parameters of the diffusion model 420.

To illustrate, FIG. 5 shows the portrait relighting system 102 comparing the second synthetic digital image 408 with a ground truth synthetic digital image 508 to determine a measure of loss 510 for the relighting training task. For example, to train the diffusion model 420, the portrait relighting system 102 accesses a synthetic portrait pair comprising the first synthetic digital image 402 and the ground truth synthetic digital image 508 (e.g., similar to the synthetic portrait pairs shown in FIG. 3). The ground truth synthetic digital image 508 has a second portrait of the subject of the first synthetic digital image 402, in which the second portrait has altered lighting according to the lighting scheme of the environment map 404.

In some embodiments, the portrait relighting system 102 modifies the parameters of the diffusion model 420 based on the measure of loss 510 to generate (e.g., on a subsequent training iteration) a new synthetic digital image that more closely resembles the ground truth synthetic digital image 508. More particularly, in one or more embodiments, the portrait relighting system 102 adjusts the parameters of the diffusion model 420 to reduce differences between the second synthetic digital image 408 and the ground truth synthetic digital image 508 based on the measure of loss 510.

Additionally, as also shown in FIG. 5, in some embodiments, the portrait relighting system 102 compares the third digital image 418 with an additional ground truth digital image 518 to determine an additional measure of loss 520 for the text-to-portrait training task. For instance, to further train the diffusion model 420, the portrait relighting system 102 accesses a real image (the additional ground truth digital image 518) and a text caption for the real image (the prompt 416). The additional ground truth digital image 518 has a ground truth portrait of the additional subject that is described by the prompt 416. As mentioned, by training the diffusion model 420 to generate portraits of real subjects, the portrait relighting system 102 helps to overcome a domain gap between synthetic images and real-world imagery.

To further illustrate, in some embodiments, the portrait relighting system 102 further modifies the parameters of the diffusion model 420 based on the additional measure of loss 520 to generate (e.g., on a subsequent training iteration) a new digital image that more closely resembles the additional ground truth digital image 518. More particularly, in one or more embodiments, the portrait relighting system 102 adjusts the parameters of the diffusion model 420 to reduce differences between the third digital image 418 and the additional ground truth digital image 518 based on the additional measure of loss 520.

Moreover, in one or more embodiments, the portrait relighting system 102 determines a training ratio for the multitask training framework. For example, the portrait relighting system 102 determines relative weights of the relighting training task and the text-to-portrait training task. For instance, the portrait relighting system 102 determines a synthetic-to-real-dataset training ratio for the diffusion model 420. To further illustrate, in one or more embodiments, the portrait relighting system 102 adjusts the parameters of the diffusion model 420 based on the measure of loss 510 and the additional measure of loss 520 according to the synthetic-to-real-dataset training ratio.

By way of example, the portrait relighting system 102 uses a 70-30 synthetic-to-real-dataset training ratio, by which 70% of the training samples are synthetic image pairs and 30% of the training samples are real-world images. This example is not limiting, and other values of synthetic-to-real-dataset training ratios are contemplated by this disclosure.

As discussed above, in one or more embodiments, the portrait relighting system 102 utilizes a diffusion model during inference to generate a new digital image based on an input digital image and an environment map. FIG. 6 illustrates the portrait relighting system 102 applying a dual diffusion process during inference that balances between identity preservation of the subject and the desired relighting effects as specified by the environment map, in accordance with one or more embodiments.

Specifically, FIG. 6 shows the portrait relighting system 102 accessing an input digital image 602 and an environment map 604. The input digital image 602 includes a portrait of a subject, and the environment map 604 defines a new lighting scheme for the subject. As shown, the portrait relighting system 102 utilizes a diffusion model 620 (e.g., the diffusion model 420 upon training) to generate a first noised image 608 based on the input digital image 602 and the environment map 604.

Moreover, in some embodiments, the portrait relighting system 102 conditions the diffusion process with a text prompt 606 that has a description of the subject. For example, the portrait relighting system 102 generates the first noised image 608 based on the input digital image 602, the environment map 604, and the text prompt 606. In the example shown in FIG. 6, the text prompt 606 reads “a beautiful woman” as describing the subject portrayed in the input digital image 602. In one or more embodiments, the portrait relighting system 102 determines the input digital image 602, the environment map 604, and the text prompt 606 from one or more inputs to a client device to generate a relit portrait based on the provided data. Additionally, in one or more embodiments, the portrait relighting system 102 also implements the dual diffusion process automatically in response to the one or more inputs.

As also shown in FIG. 6, in one or more embodiments, the portrait relighting system 102 utilizes the diffusion model 620 to generate a second noised image 618 based on the environment map 604 and the text prompt 606. For example, the portrait relighting system 102 applies a similar process to generate the second noised image 618 as it does to generate the first noised image 608, although in the second process, the portrait relighting system 102 drops out the input image. For instance, the portrait relighting system 102 uses a blank image 612 (e.g., a digital image with all black pixels, or some other solid color) with the environment map 604 to process through the diffusion model 620. Additionally, the portrait relighting system 102 conditions this input with the text prompt 606 to generate the noised image 618.

As described below in connection with FIGS. 8-11, in one or more embodiments, the portrait relighting system 102 applies a reverse diffusion process to denoise the outputs of the diffusion model 620 at a particular timestep (e.g., the noised image 608 and the noised image 618) to generate a new digital image. For example, the portrait relighting system 102 utilizes the diffusion model 620 to generate a new digital image that has a relit portrait of the input subject according to the lighting scheme of the environment map 604.

Moreover, in one or more embodiments, the portrait relighting system 102 combines the first noised image 608 and the second noised image 618 in the denoising process to generate the new digital image. To illustrate, the portrait relighting system 102 determines a score estimate for combining the two noised images at a given time step in the reverse diffusion process. To elaborate, the portrait relighting system 102 determines one or more guidance parameters to weight the input digital image 602 and the text prompt 606. For example, the portrait relighting system 102 determines a guidance parameter that indicates a degree of balance between input subject identity preservation and strength of relighting for the relit portrait. Moreover, the portrait relighting system 102 applies the guidance parameter to the first noised image 608 and the second noised image 618 to generate the new digital image.

To further illustrate, in one or more embodiments, the portrait relighting system 102 determines the score estimate based on the guidance parameter during each timestep of the diffusion process. The portrait relighting system 102 applies the score estimate to combine the noised images. For example, the portrait relighting system 102 determines, at each step of the diffusion inference, a composition of scores from both the image-conditional and the unconditional output. Specifically, for the unconditional inference, the portrait relighting system 102 drops the input image while keeping the LDR environment map and the text prompt conditioning the same as the image-conditional inference.

The score estimate at a particular timestep t is represented as follows:

$${ϵ}_{c} = {ϵ}_{θ} ( {x}_{t + 1} , ϕ , E , ϕ ) + {λ}_{T} ( {ϵ}_{θ} ( {x}_{t + 1} , I , E , T ) - {ϵ}_{θ} ( {x}_{t + 1} , I , E , ϕ ) ) + {λ}_{1} ( {ϵ}_{θ} ( {x}_{t + 1} , I , E , ϕ ) - {ϵ}_{θ} ( {x}_{t + 1} , ϕ , E , ϕ ) )$$

where λ_{T} and λ_{I} are guidance parameters. More particularly, λ_{T} is a parameter of classifier-free guidance that specifies how much the diffusion model respects the text prompts, while λ_{I} specifies how much the diffusion model respects the input portrait. In some implementations, the portrait relighting system 102 uses a guidance parameter of λ₁∈[2, 3] for the input portrait. This helps to achieve a good balance between the details and identity preservation of the input portrait while also performing good relighting.

Experimental results were generated from a user study to determine preference rates for the portrait relighting system 102 as compared with baseline systems. The preference rates indicate how often the techniques of the portrait relighting system 102 were preferred over baselines. As shown in the following table, the portrait relighting system 102 consistently outperforms the baselines in lighting, image quality, and subject identity preservation, which is indicated by all preference rates exceeding 0.5. This highlights the superior image quality over existing relighting methods and better lighting over harmonization methods.

| | Baseline 1 | Baseline 2 | Baseline 3 |
|---|---|---|---|
| Lighting | 0.92 | 0.56 | 0.65 |
| Quality | 0.57 | 0.64 | 0.73 |
| Identity | 0.52 | 0.70 | 0.65 |

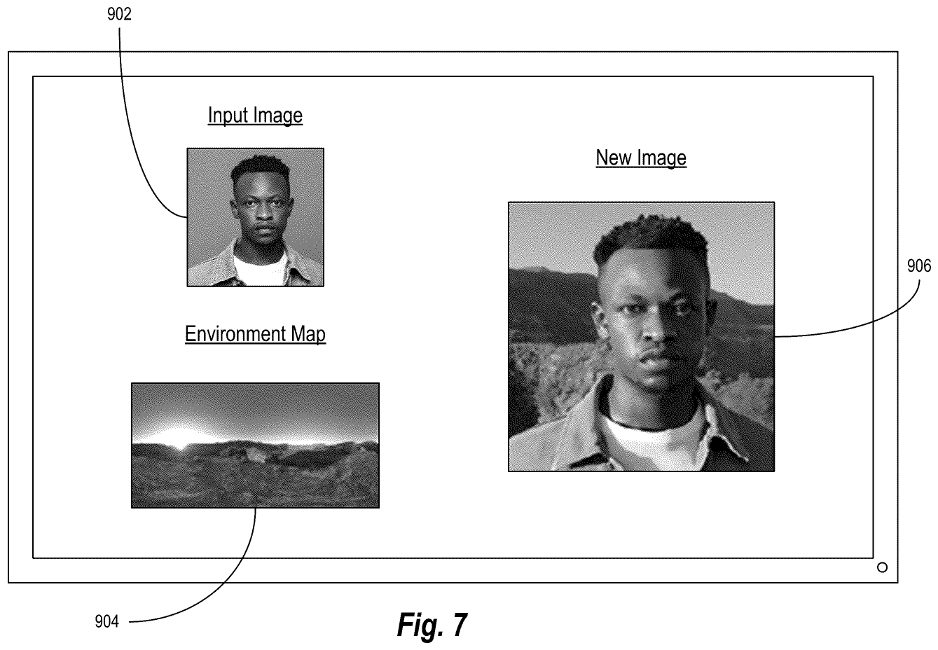

As mentioned above, in one or more embodiments, the portrait relighting system 102 receives an input digital image and environment map via a client device. Moreover, in one or more embodiments, the portrait relighting system 102 provides a new digital image with a relit portrait for display via the client device. For instance, FIG. 7 illustrates the portrait relighting system 102 providing a new digital image for display via a graphical user interface of a client device in accordance with one or more embodiments.

Specifically, FIG. 7 shows the portrait relighting system 102 receiving an input digital image 902 and environment map 904 via an input to a client device (e.g., the client device 108). For instance, the portrait relighting system 102 receives the input digital image 902 in connection with a request to modify a lighting scheme of a subject in the input digital image 902. For example, the environment map 904 is an input that the portrait relighting system 102 uses to determine a new lighting scheme for the portrait.

Additionally, FIG. 7 shows the portrait relighting system 102 providing a new digital image 906 for display via a graphical user interface of the client device. For instance, the new digital image 906 has a relit portrait of the subject based on the new lighting scheme of the environment map 904. For example, the portrait relighting system 102 generates the new digital image 906 utilizing the techniques described above in connection with FIG. 6 based on the input digital image 902 and the environment map 904. In one or more embodiments, upon generating the new digital image 906, the portrait relighting system 102 provides the new digital image 906 for display via the client device.

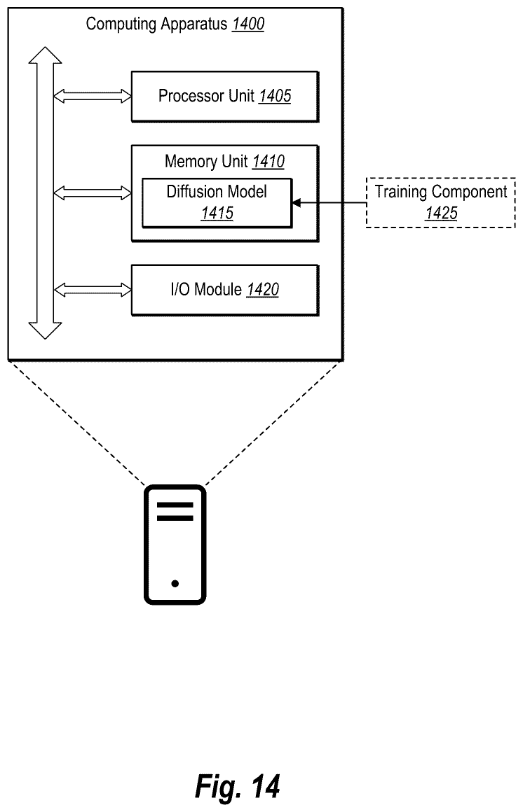

FIG. 8 shows an example of a guided diffusion model 800 according to aspects of the present disclosure. In some examples, guided diffusion model 800 describes the operation and architecture of the diffusion model 1415 described with reference to FIG. 14. The guided latent diffusion model 800 depicted in FIG. 8 is an example of, or includes aspects of, a media generation model (e.g., the diffusion model 114) as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 800 may take an original media item 805 in a pixel space 810 as input and apply forward diffusion process 815 to gradually add noise to the original media item 805 to obtain noisy media item 820 at various noise levels.

Next, a reverse diffusion process 825 (e.g., a U-Net) gradually removes the noise from the noisy media item 820 at the various noise levels to obtain an output media item 830. In some cases, an output media item 830 is created from each of the various noise levels. The output media item 830 can be compared to the original media item 805 to train the reverse diffusion process 825.

The reverse diffusion process 825 can also be guided based on a text prompt 835, or another guidance prompt, such as an image, a layout, a segmentation map, etc. The text prompt 835 can be encoded using a text encoder 840 (e.g., a multimodal encoder) to obtain guidance features 845 in guidance space 850. The guidance features 845 can be combined with the noisy media item 820 at one or more layers of the reverse diffusion process 825 to ensure that the output media item 830 includes content described by the text prompt 835. For example, guidance features 845 can be combined with the noisy features using a cross-attention block within the reverse diffusion process 825.

Methods of operating diffusion models include a Denoising Diffusion Probabilistic Model (DDPM) and a Denoising Diffusion Implicit Model (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

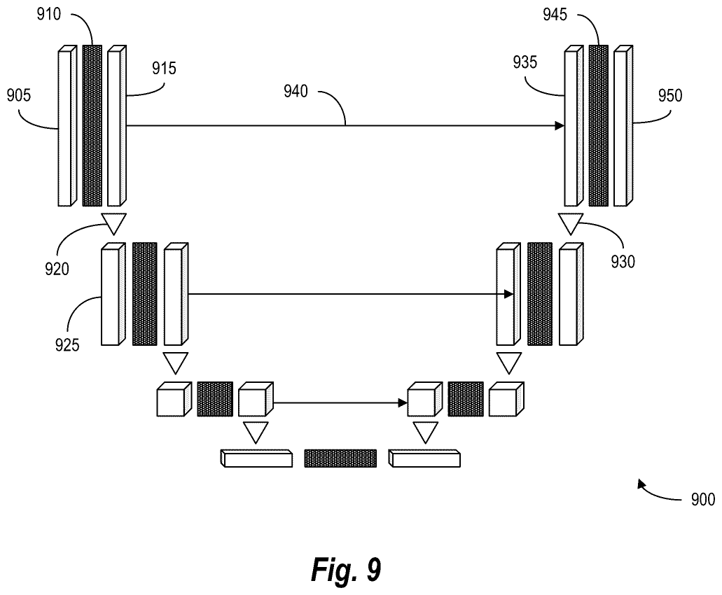

FIG. 9 shows an example of a U-Net 900 according to aspects of the present disclosure. In some examples, U-Net 900 is an example of the component that performs the reverse diffusion process 825 of guided diffusion model 800 described with reference to FIG. 8 and includes architectural elements of the diffusion model 1415 described with reference to FIG. 14. The U-Net 900 depicted in FIG. 9 is an example of, or includes aspects of, the architecture used within the reverse diffusion process described with reference to FIG. 8.

In some examples, diffusion models are based on a neural network architecture known as a U-Net. The U-Net 900 takes input features 905 having an initial resolution and an initial number of channels and processes the input features 905 using an initial neural network layer 910 (e.g., a convolutional network layer) to produce intermediate features 915. The intermediate features 915 are then down-sampled using a down-sampling layer 920 such that down-sampled features 925 have a resolution less than the initial resolution and a number of channels greater than the initial number of channels.

This process is repeated multiple times, and then the process is reversed. That is, the down-sampled features 925 are up-sampled using up-sampling process 930 to obtain up-sampled features 935. The up-sampled features 935 can be combined with intermediate features 915 having the same resolution and number of channels via a skip connection 940. These inputs are processed using a final neural network layer 945 to produce output features 950. In some cases, the output features 950 have the same resolution as the initial resolution and the same number of channels as the initial number of channels.

In some cases, U-Net 900 takes additional input features to produce conditionally generated output. For example, the additional input features could include a vector representation of an input prompt. The additional input features can be combined with the intermediate features 915 within the neural network at one or more layers. For example, a cross-attention module can be used to combine the additional input features and the intermediate features 915.

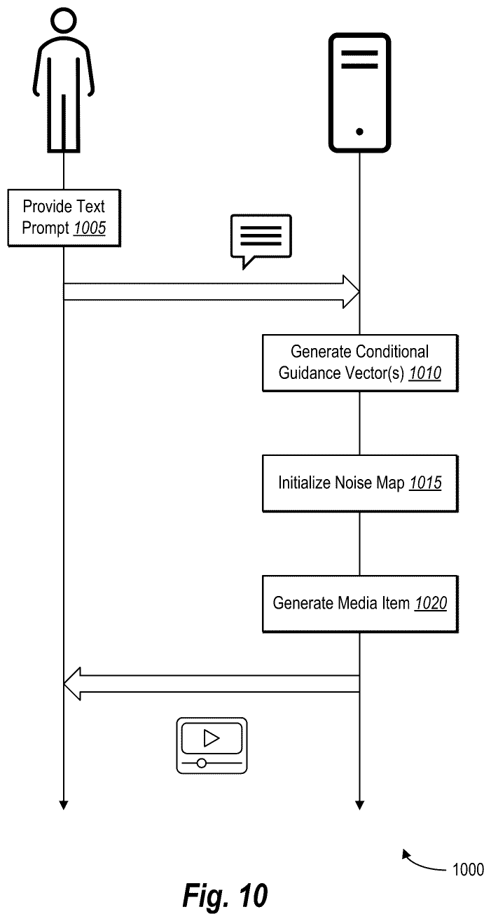

FIG. 10 shows an example of a method 1000 for conditional media generation according to aspects of the present disclosure. In some examples, method 1000 describes an operation of the diffusion model 1415 described with reference to FIG. 14 such as an application of the guided diffusion model 800 described with reference to FIG. 8. In some examples, these operations are performed by a system including a processor executing a set of codes to control functional elements of an apparatus such as the media generation model described in FIG. 8.

Additionally, or alternatively, steps of the method 1000 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1005, a user provides a text prompt describing content to be included in a generated media item. For example, a user may provide the prompt “a person playing with a cat.” In some examples, guidance can be provided in a form other than text, such as via an image, a sketch, or a layout.

At operation 1010, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1015, a noise map is initialized that includes random noise. The noise map may be in a pixel space or a latent space. By initializing a media item with random noise, different variations of a media item including the content described by the conditional guidance can be generated.

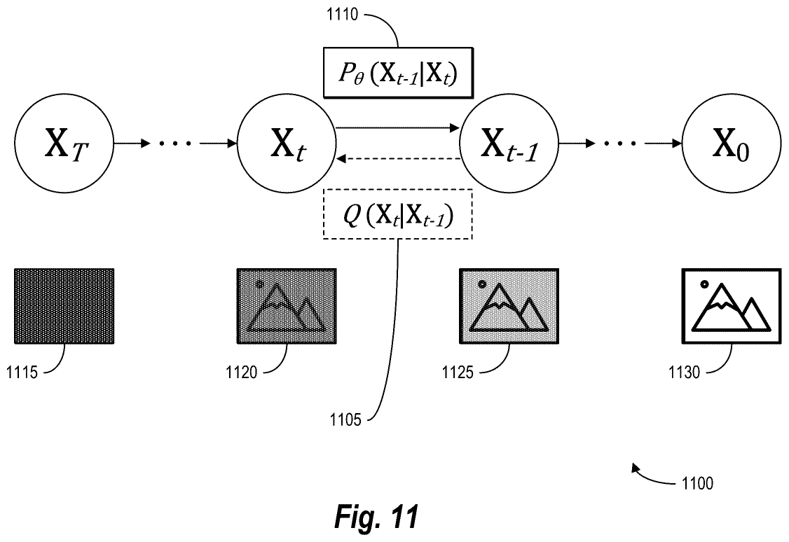

At operation 1020, the system generates a media item based on the noise map and the conditional guidance vector. For example, the media item may be generated using a reverse diffusion process as described with reference to FIG. 11.

FIG. 11 shows a diffusion process 1100 according to aspects of the present disclosure. In some examples, diffusion process 1100 describes an operation of the diffusion model 1415 described with reference to FIG. 14, such as the reverse diffusion process 825 of guided diffusion model 800 described with reference to FIG. 8.

As described above with reference to FIG. 8, using a diffusion model can involve both a forward diffusion process 1105 for adding noise to a media item (or features in a latent space) and a reverse diffusion process 1110 for denoising the media item (or features) to obtain a denoised media item. The forward diffusion process 1105 can be represented as q(xₜ|xₜ₋₁), and the reverse diffusion process 1110 can be represented as p(xₜ₋₁|xₜ). In some cases, the forward diffusion process 1105 is used during training to generate media items with successively greater noise, and a neural network is trained to perform the reverse diffusion process 1110 (i.e., to successively remove the noise).

In an example forward process for a latent diffusion model, the model maps an observed variable x₀ (either in a pixel space or a latent space) and intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1110, the model begins with noisy data x_{T}, such as a noisy media item 1115 and denoises the data to obtain the p(xₜ₋₁|xₜ). At each step t−1, the reverse diffusion process 1110 takes xₜ, such as first intermediate media item 1120, and t as input. Here, t represents a step in the sequence of transitions associated with different noise levels. The reverse diffusion process 1110 outputs xₜ₋₁, such as second intermediate media item 1125 iteratively until x_{T} reverts back to x₀, the original media item 1130. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) .$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) ,$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

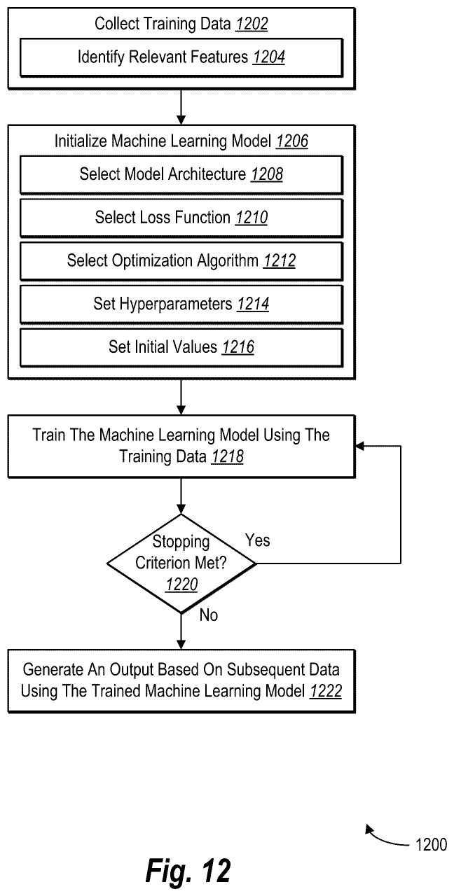

FIG. 12 is a flow diagram depicting an algorithm as a step-by-step procedure 1200 in an example implementation of operations performable for training a machine-learning model. In some embodiments, the procedure 1200 describes an operation of the training component 1425 described for configuring the diffusion model 1415 as described with reference to FIG. 14. The procedure 1200 provides one or more examples of generating training data, use of the training data to train a machine-learning model, and use of the trained machine-learning model to perform a task.

To begin in this example, a machine-learning system collects training data (block 1202) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1204) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1206). Initialization of the machine-learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1210). The loss function is utilized to measure a difference between an output of the machine-learning model (i.e., predictions) and target values (e.g., as expressed by the training data) to be used to train the machine-learning model. Additionally, an optimization algorithm is selected (block 1212) that is to be used in conjunction with the loss function to optimize parameters of the machine-learning model during training, examples of which include gradient descent, stochastic gradient descent (SGD), and so forth.

Initialization of the machine-learning model further includes setting hyperparameters (block 1214) and initial values (block 1216) of the machine-learning model, examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1220), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 1200 continues training of the machine-learning model using the training data (block 1218) in this example.

If the stopping criterion is met (“yes” from decision block 1220), the trained machine-learning model is then utilized to generate an output based on subsequent data (block 1222). The trained machine-learning model, for instance, is trained to perform a task as described above and therefore once trained is configured to perform that task based on subsequent data received as an input and processed by the machine-learning model.

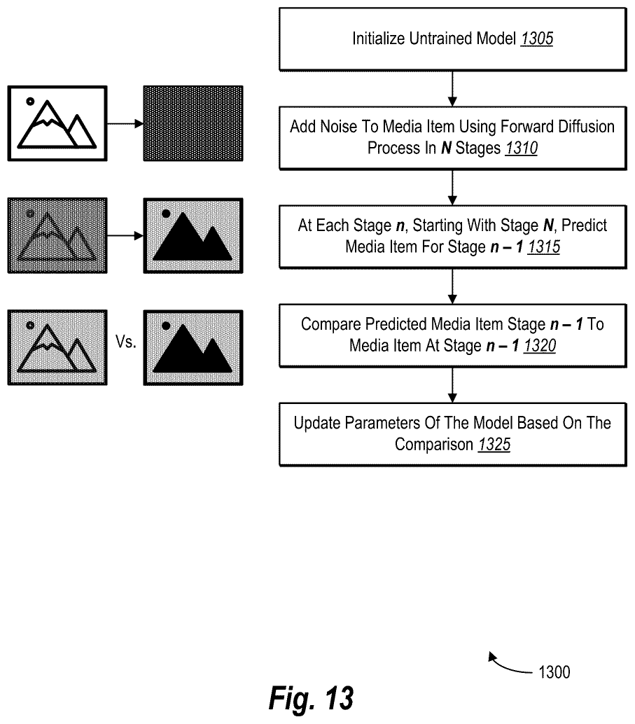

FIG. 13 shows an example of a method 1300 for training a diffusion model according to aspects of the present disclosure. In some embodiments, the method 1300 describes an operation of the training component 1425 described for configuring the diffusion model 1415 as described with reference to FIG. 14. The method 1300 represents an example for training a reverse diffusion process as described above with reference to FIG. 11. In some examples, these operations are performed by a system including a processor executing a set of codes to control functional elements of an apparatus, such as the guided diffusion model described in FIG. 8.

Additionally, or alternatively, certain processes of method 1300 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the user initializes an untrained model. Initialization can include defining the architecture of the model and establishing initial values for the model parameters. In some cases, the initialization can include defining hyper-parameters such as the number of layers, the resolution and channels of each of the layer blocks, the location of skip connections, and the like.

At operation 1310, the system adds noise to a media item using a forward diffusion process in N stages. In some cases, the forward diffusion process is a fixed process where Gaussian noise is successively added to the media item. In latent diffusion models, the Gaussian noise may be successively added to features in a latent space.

At operation 1315, the system at each stage n, starting with stage N, uses a reverse diffusion process to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1320, the system compares predicted output (e.g., media item or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1325, the system updates parameters of the model based on the comparison. For example, parameters of a U-Net may be updated using gradient descent. Time-dependent parameters of the Gaussian transitions can also be learned.

FIG. 14 shows an example of a computing apparatus 1400 according to aspects of the present disclosure. The computing apparatus 1400 may include an example of, or aspects of, the guided diffusion model described with reference to FIG. 8 and the U-Net described with reference to FIG. 9. In some embodiments, computing apparatus 1400 includes processor unit 1405, memory unit 1410, diffusion model 1415, I/O module 1420, and training component 1425. Training component 1425 updates parameters of the diffusion model 1415 stored in memory unit 1410. In some examples, the training component 1425 is located outside the computing apparatus 1400.

Processor unit 1405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1405 is configured to operate a memory array using a memory controller. In other cases, a memory controller is integrated into processor unit 1405. In some cases, processor unit 1405 is configured to execute computer-readable instructions stored in memory unit 1410 to perform various functions. In some aspects, processor unit 1405 includes special purpose components for modem processing, baseband processing, digital signal processing, or transmission processing. According to some aspects, processor unit 1405 comprises one or more processors described with reference to FIG. 17.

Memory unit 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1405 to perform various functions described herein.

In some cases, memory unit 1410 includes a basic input/output system (BIOS) that controls basic hardware or software operations, such as an interaction with peripheral components or devices. In some cases, memory unit 1410 includes a memory controller that operates memory cells of memory unit 1410. For example, the memory controller may include a row decoder, column decoder, or both. In some cases, memory cells within memory unit 1410 store information in the form of a logical state. According to some aspects, memory unit 1410 is an example of the memory 1704 described with reference to FIG. 17.

According to some aspects, computing apparatus 1400 uses one or more processors of processor unit 1405 to execute instructions stored in memory unit 1410 to perform functions described herein. For example, the computing apparatus 1400 may generate a new digital image depicting a relit portrait according to an environment map.

The memory unit 1410 may include a diffusion model 1415 (e.g., the diffusion model 114) trained to generate the new digital image depicting the relit portrait according to the environment map. For example, after training, the diffusion model 1415 may perform inferencing operations as described with reference to FIGS. 10 and 11 to generate the new digital image.

In some embodiments, the diffusion model 1415 is an artificial neural network (ANN) such as the guided diffusion model described with reference to FIG. 8 and the U-Net described with reference to FIG. 9. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of diffusion model 1415 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1425 may train the diffusion model 1415. For example, parameters of the diffusion model 1415 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 12 and 13). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion model 1415 can be used to make predictions on new, unseen data (i.e., during inference).

I/O module 1420 receives inputs from and transmits outputs of the computing apparatus 1400 to other devices or users. For example, I/O module 1420 receives inputs for the diffusion model 1415 and transmits outputs of the diffusion model 1415. According to some aspects, I/O module 1420 is an example of the I/O interface 1708 described with reference to FIG. 17.

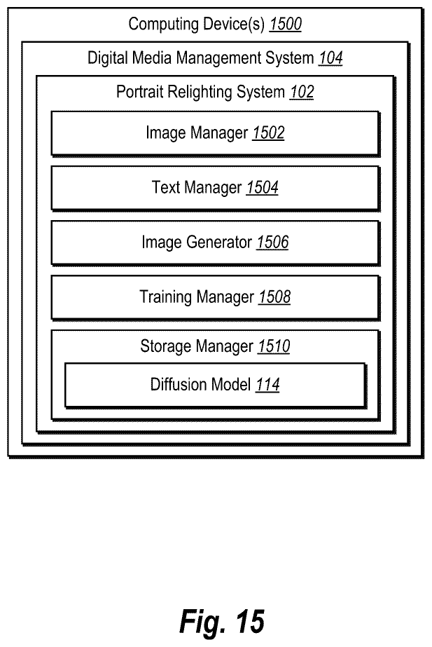

Turning now to FIG. 15, additional detail will be provided regarding components and capabilities of one or more embodiments of the portrait relighting system 102. In particular, FIG. 15 illustrates an example portrait relighting system 102 executed by a computing device(s) 1500 (e.g., the server device(s) 106 or the client device 108). As shown by the embodiment of FIG. 15, the computing device(s) 1500 includes or hosts the digital media management system 104 and/or the portrait relighting system 102. Furthermore, as shown in FIG. 15, the portrait relighting system 102 includes an image manager 1502, a text manager 1504, an image generator 1506, a training manager 1508, and a storage manager 1510.

As shown in FIG. 15, the portrait relighting system 102 includes an image manager 1502. In some implementations, the image manager 1502 determines (e.g., receives, obtains, accesses, identifies, etc.) one or more digital images in connection with training and/or applying a diffusion model. For example, the image manager 1502 accesses synthetic image pairs to train the diffusion model to generate new images with different lighting schemes. As another example, the image manager 1502 receives an input digital image and an input environment map to process through the diffusion model to generate a new digital image with a relit portrait.

In addition, as shown in FIG. 15, the portrait relighting system 102 includes a text manager 1504. In some implementations, the text manager 1504 determines (e.g., receives, obtains, accesses, identifies, etc.) a text caption for a digital image, such as a training text prompt to condition the digital image during training of the diffusion model.

Moreover, as shown in FIG. 15, the portrait relighting system 102 includes an image generator 1506. In some implementations, the image generator 1506 utilizes the diffusion model to generate a new digital image. For example, the image generator 1506 applies the diffusion model in a reverse diffusion process to generate noised images that successively have less noise until a final output image is generated.

Furthermore, as shown in FIG. 15, the portrait relighting system 102 includes a training manager 1508. In some implementations, the training manager 1508 trains (e.g., modifies parameters of) one or more machine learning models, as described above, including the diffusion model(s) described herein.

Additionally, as shown in FIG. 15, the portrait relighting system 102 includes a storage manager 1510. In some implementations, the storage manager 1510 stores information (e.g., via one or more memory devices) on behalf of the portrait relighting system 102. For example, the storage manager 1510 includes the diffusion model 114 (e.g., stores parameters of the diffusion model 114). As another example, the storage manager 1510 stores digital images, environment maps, and text captions/prompts for training and/or application of the diffusion model 114.

Each of the components 1502-1510 of the portrait relighting system 102 includes software, hardware, or both. For example, the components 1502-1510 include one or more instructions stored on a computer-readable storage medium and executable by processors of one or more computing devices, such as a client device or server device. When executed by the one or more processors, in some implementations, the computer-executable instructions of the portrait relighting system 102 cause the computing device(s) to perform the methods described herein. Alternatively, in one or more implementations, the components 1502-1510 include hardware, such as a special purpose processing device to perform a certain function or group of functions. Alternatively, in some implementations, the components 1502-1510 of the portrait relighting system 102 include a combination of computer-executable instructions and hardware.

Furthermore, the components 1502-1510 of the portrait relighting system 102 are, for example, implemented as one or more operating systems, as one or more stand-alone applications, as one or more modules of an application, as one or more plug-ins, as one or more library functions, as one or more functions callable by other applications, and/or as a cloud-computing model. Thus, in some implementations, the components 1502-1510 are implemented as a stand-alone application, such as a desktop or mobile application. Furthermore, in various implementations, the components 1502-1510 are implemented as one or more web-based applications hosted on a remote server. In some implementations, the components 1502-1510 are implemented in a suite of mobile device applications or “apps.” To illustrate, in some implementations, the components 1502-1510 are implemented in an application, including but not limited to Adobe After Effects, Adobe Creative Cloud, Adobe Lightroom, Adobe Photoshop, Adobe Premiere, and Adobe Sensei. The foregoing are either registered trademarks or trademarks of Adobe in the United States and/or other countries.

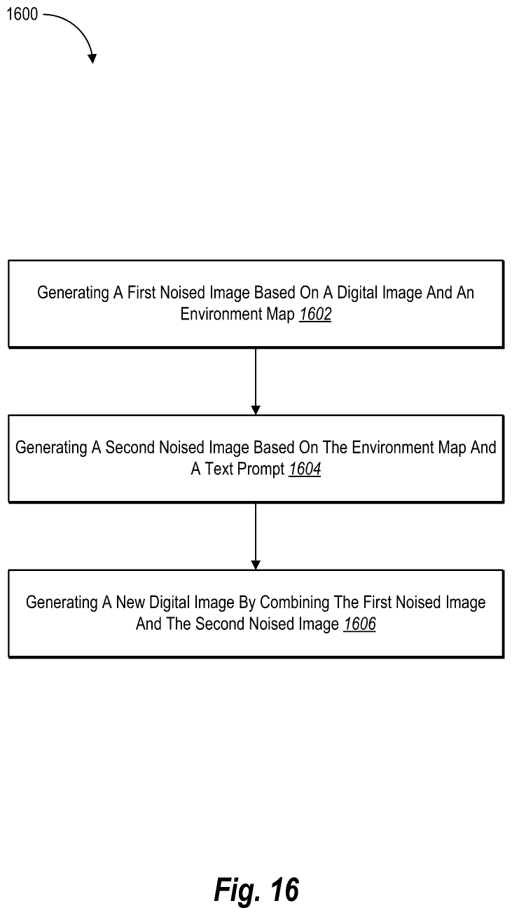

FIGS. 1-15, the corresponding text, and the examples provide a number of different methods, systems, devices, and non-transitory computer-readable media of the portrait relighting system 102. In addition to the foregoing, one or more embodiments are described in terms of flowcharts comprising acts for accomplishing a particular result, as shown in FIG. 16. In some implementations, the processes of the portrait relighting system 102 are performed with more or fewer acts. Furthermore, in various implementations, the acts are performed in differing orders. Additionally, in some implementations, the acts described herein are repeated or performed in parallel with one another or in parallel with different instances of the same or similar acts.

As mentioned, FIG. 16 illustrates a flowchart of a series of acts 1600 for generating a relit portrait utilizing a diffusion model in accordance with one or more implementations. While FIG. 16 illustrates acts according to one implementation, alternative implementations omit, add to, reorder, and/or modify any of the acts shown in FIG. 16. In one or more implementations, the acts of FIG. 16 are performed as part of a method (e.g., a computer-implemented method). Alternatively, in one or more implementations, a non-transitory computer-readable storage medium comprises instructions that, when executed by one or more processors, cause a computing device to perform the acts of FIG. 16. In some implementations, a system performs the acts of FIG. 16.

As shown in FIG. 16, the series of acts 1600 includes an act 1602 of generating a first noised image based on a digital image and an environment map, an act 1604 of generating a second noised image based on the environment map and a text prompt, and an act 1606 of generating a new digital image by combining the first noised image and the second noised image.

In particular, in some implementations, the act 1602 includes generating, utilizing a diffusion model, a first noised image based on a first digital image comprising a portrait of a subject and based on an environment map defining a new lighting scheme for the subject, the act 1604 includes generating, utilizing the diffusion model, a second noised image based on the environment map and a text prompt comprising a description of the subject, and the act 1606 includes generating, utilizing the diffusion model, a new digital image comprising a relit portrait of the subject by combining the first noised image and the second noised image.

For example, in some implementations, the series of acts 1600 includes generating the first noised image by utilizing the diffusion model to generate the first noised image based on the first digital image, the environment map, and the text prompt comprising the description of the subject. Moreover, in some implementations, the series of acts 1600 includes generating the new digital image by: determining a guidance parameter that indicates a degree of balance between subject identity preservation and strength of relighting for the relit portrait; determining, during a timestep of the diffusion model, a score estimate based on the guidance parameter; and applying the score estimate to the first noised image and the second noised image.

Furthermore, in some implementations, the series of acts 1600 includes accessing a first synthetic training image comprising a first synthetic portrait of a training subject, and a training environment map defining a training lighting scheme for the training subject; generating, utilizing the diffusion model, a second synthetic digital image comprising a relit portrait of the training subject based on the first synthetic training image and the training environment map; determining a measure of loss based on the second synthetic digital image and a ground truth synthetic digital image comprising a second synthetic portrait of the training subject with altered lighting according to the training lighting scheme of the training environment map; and adjusting parameters of the diffusion model to reduce differences between the second synthetic digital image and the ground truth synthetic digital image based on the measure of loss.

Additionally, in some implementations, the series of acts 1600 includes generating, utilizing the diffusion model, a third digital image comprising a generated portrait of an additional subject based on a text prompt comprising a description of the additional subject; determining an additional measure of loss based on the third digital image and an additional ground truth digital image comprising a ground truth portrait of the additional subject; and adjusting the parameters of the diffusion model to reduce differences between the third digital image and the additional ground truth digital image based on the additional measure of loss. Moreover, in some implementations, the series of acts 1600 includes determining a synthetic-to-real-dataset training ratio for the diffusion model; and adjusting the parameters of the diffusion model based on the measure of loss and the additional measure of loss according to the synthetic-to-real-dataset training ratio.

In addition, in some implementations, the series of acts 1600 includes accessing a first synthetic digital image comprising a first portrait of a subject; accessing an environment map defining a new lighting scheme for the subject; generating, utilizing a diffusion model, a second synthetic digital image comprising a relit portrait of the subject based on the first synthetic digital image and the environment map; determining a measure of loss based on the second synthetic digital image and a ground truth synthetic digital image comprising a second portrait of the subject with altered lighting according to the new lighting scheme of the environment map; and adjusting parameters of the diffusion model to reduce differences between the second synthetic digital image and the ground truth synthetic digital image based on the measure of loss.

Moreover, in some implementations, the series of acts 1600 includes generating the first synthetic digital image comprising the first portrait of the subject by synthesizing a first rendering of the subject according to a first lighting scheme; and generating the ground truth synthetic digital image comprising the second portrait of the subject by synthesizing a second rendering of the subject according to the new lighting scheme of the environment map. Furthermore, in some implementations, the series of acts 1600 includes generating the second synthetic digital image by utilizing the diffusion model to generate the second synthetic digital image from the first synthetic digital image and the environment map conditioned with a supplemental text prompt comprising a description of the subject.

Additionally, in some implementations, the series of acts 1600 includes generating, utilizing the diffusion model, a third digital image comprising a generated portrait of an additional subject based on a text prompt comprising a description of the additional subject; determining an additional measure of loss based on the third digital image and an additional ground truth digital image comprising a ground truth portrait of the additional subject; and adjusting the parameters of the diffusion model to reduce differences between the third digital image and the additional ground truth digital image based on the additional measure of loss. Moreover, in some implementations, the series of acts 1600 includes generating the third digital image by generating, utilizing the diffusion model, the third digital image from a blank image conditioned with the text prompt. Furthermore, in some implementations, the series of acts 1600 includes adjusting the parameters of the diffusion model based on the measure of loss and the additional measure of loss according to a synthetic-to-real-dataset training ratio for the diffusion model.

Additionally, in some implementations, the series of acts 1600 includes generating, utilizing the diffusion model, a first noised image based on an input digital image comprising an input portrait of an input subject and based on an input environment map defining an input lighting scheme for the input subject; generating, utilizing the diffusion model, a second noised image based on the input environment map and a text prompt comprising a description of the input subject; and generating, utilizing the diffusion model, a new digital image comprising a relit portrait of the input subject by combining the first noised image and the second noised image. Moreover, in some implementations, the series of acts 1600 includes generating the new digital image by applying a guidance parameter to the first noised image and the second noised image, wherein the guidance parameter indicates a degree of balance between input subject identity preservation and strength of relighting for the relit portrait.

In addition, in some implementations, the series of acts 1600 includes generating, utilizing a diffusion model, a first noised image based on a first digital image comprising a portrait of a subject and based on an environment map defining a new lighting scheme for the subject; generating, utilizing the diffusion model, a second noised image based on the environment map and a text prompt comprising a description of the subject; and generating, utilizing the diffusion model, a new digital image comprising a relit portrait of the subject by combining the first noised image and the second noised image. For example, in some implementations, the series of acts 1600 includes generating the first noised image by processing the first digital image, the environment map, and the text prompt through the diffusion model to generate a noised image output. Moreover, in some implementations, the series of acts 1600 includes generating the new digital image by applying a guidance parameter to the first noised image and the second noised image.

Furthermore, in some implementations, the series of acts 1600 includes accessing a first synthetic training image comprising a first synthetic portrait of a training subject, and a training environment map defining a training lighting scheme for the training subject; generating, utilizing the diffusion model, a second synthetic digital image comprising a relit portrait of the training subject based on the first synthetic training image and the training environment map; and adjusting parameters of the diffusion model to reduce differences between the second synthetic digital image and a ground truth synthetic digital image comprising a second synthetic portrait of the training subject with altered lighting according to the training lighting scheme of the training environment map.

Additionally, in some implementations, the series of acts 1600 includes generating, utilizing the diffusion model, a third digital image comprising a generated portrait of an additional subject based on a text prompt comprising a description of the additional subject; determining a synthetic-to-real-dataset training ratio for the diffusion model; and adjusting, according to the synthetic-to-real-dataset training ratio, the parameters of the diffusion model to reduce differences between the third digital image and an additional ground truth digital image comprising a ground truth portrait of the additional subject.

Furthermore, in some implementations, the series of acts 1600 includes receiving the first digital image via an input to a client device in connection with a request to modify a lighting scheme of the subject in the first digital image; and providing, for display via a graphical user interface of the client device, the new digital image comprising the relit portrait of the subject based on the new lighting scheme of the environment map.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general purpose computer to turn the general purpose computer into a special purpose computer implementing elements of the disclosure. The computer-executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 17 illustrates, in block diagram form, an example computing device 1700 (e.g., the computing device(s) 1500, the client device 108, and/or the server device(s) 106) that may be configured to perform one or more of the processes described above. As shown by FIG. 17, the computing device can comprise a processor(s) 1702, memory 1704, a storage device 1706, an I/O interface 1708, and a communication interface 1710.

In particular embodiments, processor(s) 1702 includes hardware for executing instructions, such as those making up a computer program. As an example, and not by way of limitation, to execute instructions, processor(s) 1702 may retrieve (or fetch) the instructions from an internal register, an internal cache, memory 1704, or a storage device 1706 and decode and execute them. The computing device 1700 includes memory 1704, which is coupled to the processor(s) 1702. The memory 1704 may be used for storing data, metadata, and programs for execution by the processor(s). The memory 1704 may include one or more of volatile and non-volatile memories. The memory 1704 may be internal or distributed memory. The computing device 1700 includes a storage device 1706 includes storage for storing data or instructions. As an example, and not by way of limitation, storage device 1706 can comprise a non-transitory storage medium described above. The computing device 1700 also includes one or more input or output (“I/O”) devices/interfaces 1708, which are provided to allow a user to provide input to (such as user strokes), receive output from, and otherwise transfer data to and from the computing device 1700. These I/O devices/interfaces 1708 may include a mouse, keypad or a keyboard, a touch screen, camera, optical scanner, network interface, modem, other known I/O devices or a combination of such I/O devices/interfaces 1708.

The computing device 1700 can further include a communication interface 1710. The communication interface 1710 can include hardware, software, or both. The communication interface 1710 can provide one or more interfaces for communication (such as, for example, packet-based communication) between the computing device and one or more other computing devices (e.g., computing device 1700) or one or more networks. The computing device 1700 can further include a bus 1712. The bus 1712 can comprise hardware, software, or both that couples components of computing device 1700 to each other.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, utilizing a diffusion model, a first noised image based on a first digital image comprising a portrait of a subject and based on an environment map defining a new lighting scheme for the subject;
generating, utilizing the diffusion model, a second noised image based on the environment map and a text prompt comprising a description of the subject; and
generating, utilizing the diffusion model, a new digital image comprising a relit portrait of the subject by combining the first noised image and the second noised image.

2. The computer-implemented method of claim 1, wherein generating the first noised image comprises utilizing the diffusion model to generate the first noised image based on the first digital image, the environment map, and the text prompt comprising the description of the subject.

3. The computer-implemented method of claim 1, wherein generating the new digital image comprises:
determining a guidance parameter that indicates a degree of balance between subject identity preservation and strength of relighting for the relit portrait;
determining, during a timestep of the diffusion model, a score estimate based on the guidance parameter; and
applying the score estimate to the first noised image and the second noised image.

4. The computer-implemented method of claim 1, further comprising:
accessing a first synthetic training image comprising a first synthetic portrait of a training subject, and a training environment map defining a training lighting scheme for the training subject;
generating, utilizing the diffusion model, a second synthetic digital image comprising a relit portrait of the training subject based on the first synthetic training image and the training environment map;
determining a measure of loss based on the second synthetic digital image and a ground truth synthetic digital image comprising a second synthetic portrait of the training subject with altered lighting according to the training lighting scheme of the training environment map; and
adjusting parameters of the diffusion model to reduce differences between the second synthetic digital image and the ground truth synthetic digital image based on the measure of loss.

5. The computer-implemented method of claim 4, further comprising:
generating, utilizing the diffusion model, a third digital image comprising a generated portrait of an additional subject based on a text prompt comprising a description of the additional subject;
determining an additional measure of loss based on the third digital image and an additional ground truth digital image comprising a ground truth portrait of the additional subject; and
adjusting the parameters of the diffusion model to reduce differences between the third digital image and the additional ground truth digital image based on the additional measure of loss.

6. The computer-implemented method of claim 5, further comprising:
determining a synthetic-to-real-dataset training ratio for the diffusion model; and
adjusting the parameters of the diffusion model based on the measure of loss and the additional measure of loss according to the synthetic-to-real-dataset training ratio.

7. A system comprising:
one or more memory devices; and
one or more processors coupled to the one or more memory devices that cause the system to perform operations comprising:
accessing a first synthetic digital image comprising a first portrait of a subject;
accessing an environment map defining a new lighting scheme for the subject;
generating, utilizing a diffusion model, a second synthetic digital image comprising a relit portrait of the subject based on the first synthetic digital image and the environment map;
determining a measure of loss based on the second synthetic digital image and a ground truth synthetic digital image comprising a second portrait of the subject with altered lighting according to the new lighting scheme of the environment map; and
adjusting parameters of the diffusion model to reduce differences between the second synthetic digital image and the ground truth synthetic digital image based on the measure of loss.

8. The system of claim 7, wherein the operations further comprise:
generating the first synthetic digital image comprising the first portrait of the subject by synthesizing a first rendering of the subject according to a first lighting scheme; and
generating the ground truth synthetic digital image comprising the second portrait of the subject by synthesizing a second rendering of the subject according to the new lighting scheme of the environment map.

9. The system of claim 7, wherein generating the second synthetic digital image comprises utilizing the diffusion model to generate the second synthetic digital image from the first synthetic digital image and the environment map conditioned with a supplemental text prompt comprising a description of the subject.

10. The system of claim 7, wherein the operations further comprise:
generating, utilizing the diffusion model, a third digital image comprising a generated portrait of an additional subject based on a text prompt comprising a description of the additional subject;
determining an additional measure of loss based on the third digital image and an additional ground truth digital image comprising a ground truth portrait of the additional subject; and
adjusting the parameters of the diffusion model to reduce differences between the third digital image and the additional ground truth digital image based on the additional measure of loss.

11. The system of claim 10, wherein generating the third digital image comprises generating, utilizing the diffusion model, the third digital image from a blank image conditioned with the text prompt.

12. The system of claim 10, wherein the operations further comprise adjusting the parameters of the diffusion model based on the measure of loss and the additional measure of loss according to a synthetic-to-real-dataset training ratio for the diffusion model.

13. The system of claim 7, wherein the operations further comprise:
generating, utilizing the diffusion model, a first noised image based on an input digital image comprising an input portrait of an input subject and based on an input environment map defining an input lighting scheme for the input subject;
generating, utilizing the diffusion model, a second noised image based on the input environment map and a text prompt comprising a description of the input subject; and
generating, utilizing the diffusion model, a new digital image comprising a relit portrait of the input subject by combining the first noised image and the second noised image.

14. The system of claim 13, wherein generating the new digital image comprises applying a guidance parameter to the first noised image and the second noised image, wherein the guidance parameter indicates a degree of balance between input subject identity preservation and strength of relighting for the relit portrait.

15. A non-transitory computer-readable medium storing instructions thereon that, when executed by at least one processor, cause the at least one processor to perform operations comprising:
generating, utilizing a diffusion model, a first noised image based on a first digital image comprising a portrait of a subject and based on an environment map defining a new lighting scheme for the subject;
generating, utilizing the diffusion model, a second noised image based on the environment map and a text prompt comprising a description of the subject; and
generating, utilizing the diffusion model, a new digital image comprising a relit portrait of the subject by combining the first noised image and the second noised image.

16. The non-transitory computer-readable medium of claim 15, wherein generating the first noised image comprises processing the first digital image, the environment map, and the text prompt through the diffusion model to generate a noised image output.

17. The non-transitory computer-readable medium of claim 15, wherein generating the new digital image comprises applying a guidance parameter to the first noised image and the second noised image.

18. The non-transitory computer-readable medium of claim 15, wherein the operations further comprise:
accessing a first synthetic training image comprising a first synthetic portrait of a training subject, and a training environment map defining a training lighting scheme for the training subject;
generating, utilizing the diffusion model, a second synthetic digital image comprising a relit portrait of the training subject based on the first synthetic training image and the training environment map; and
adjusting parameters of the diffusion model to reduce differences between the second synthetic digital image and a ground truth synthetic digital image comprising a second synthetic portrait of the training subject with altered lighting according to the training lighting scheme of the training environment map.

19. The non-transitory computer-readable medium of claim 18, wherein the operations further comprise:
generating, utilizing the diffusion model, a third digital image comprising a generated portrait of an additional subject based on a text prompt comprising a description of the additional subject;
determining a synthetic-to-real-dataset training ratio for the diffusion model; and
adjusting, according to the synthetic-to-real-dataset training ratio, the parameters of the diffusion model to reduce differences between the third digital image and an additional ground truth digital image comprising a ground truth portrait of the additional subject.

20. The non-transitory computer-readable medium of claim 15, wherein the operations further comprise:
receiving the first digital image via an input to a client device in connection with a request to modify a lighting scheme of the subject in the first digital image; and
providing, for display via a graphical user interface of the client device, the new digital image comprising the relit portrait of the subject based on the new lighting scheme of the environment map.
